(19) United States
(12) Patent Application Publication
(10) Pub. No.: US 2012/0327113 A1
(43) Pub. Date: Dec. 27, 2012

(54) System and Method for Inserting Messages Displayed to a User When Viewing a Venue

(76) Inventor: Charles D. Huston, Austin, TX (US)

(21) Appl. No.: 13/605,370

(22) Filed: Sep. 6, 2012

Related U.S. Application Data
(63) Continuation of application No. 13/152,476, filed on Jun. 3, 2011.

(51) Int. Cl. G09G 5/00

(52) U.S. Cl. 345/632

(57) ABSTRACT

A system and method for viewing artificial reality messages, such as at an event at a venue, where the messages are geo-referenced, artificial reality words or symbols and enhanced for greater comprehension or relevancy to the user. Typically, the messages are geo-referenced to a moving participant or to a fixed location at the venue. Using the spectator's chosen location as the viewing origin, an artificial reality message or product is inserted into the spectator's perspective view of the venue. The enhancement involves changing the content for context, or changing the perspective, orientation, size, background, font, or lighting for comprehension.

### CONTINUING DATA

The present application is a continuation of U.S. patent application Ser. No. 13/152,476 filed Jun. 3, 2011.

### BACKGROUND

1. Field of the Invention

This invention relates to a system and method for inserting and enhancing artificial reality messages displayed to a user of a graphics device, such as when viewing an event, such as a sporting event, concert, rally, gathering, meeting, location preview, or the like, at a venue. Preferably, the message enhancement involves changing the content for context, or changing the perspective, orientation, size, background, font, or lighting associated with the message for better comprehension.

2. Description of the Related Art

U.S. Pat. Nos. 7,855,638; 8,249,626; and 8,207,843 and U.S. Publication Nos. 2007/0117576 and 2008/0198230 relate generally to viewing people, places, and events, such as sporting events, using positioning and artificial reality to improve the event viewing experience. Commercial applications of augmented reality exist such as Layar, Wikitude, Junaio, Sekai Camera and others which use augmented reality to aid finding information about points of interest. See, e.g., www.layar.com, www.wikitude.org/en/, and www.junaio.com.

Products or services that are tailored to the user are prevalent, such as advertising models from Google based on search terms or advertising based on personal information of a user. For example, Apple postulates displaying advertising to a mobile customer using one of its devices based on marketing factors. To compute marketing factors the Apple system captures not only the machine identity, but search history, personal demographics, time of day, location, weather, loyalty program membership, media library, user opinion or opinions of friends and family, etc. (collectively, referred to as “marketing factors”). See e.g., U.S. Publication Nos. 2010/0125492; 2009/0175499; 2009/0017787; 2009/0003662; and 2009/0300122, and U.S. Pat. No. 7,933,900. Links to and use of social media, such as Facebook and Twitter, sometimes paired with location, are also possible indicators of a user behavior and user demographics. See e.g., U.S. Publication No. 2009/0003662; and U.S. Pat. Nos. 7,188,153; 7,117,254; 7,069,308. See also, U.S. Publication No. 2011/0090252. All references cited herein are incorporated by reference herein as if fully set forth herein.

### SUMMARY OF THE INVENTION

Generally speaking, the system and methods of the present invention enhance artificial reality messages inserted into a graphics device of a user when viewing people, places, or things, such as viewing an event at a venue, e.g., a sporting event, concert, rally, gathering, location preview, or the like. In one form, the message enhancement involves changing the perspective, orientation, size, background, font, or lighting associated with the message for comprehension. In another form, the message enhancement involves changing the message content based on context, such as marketing factors. In another form, a product image may be inserted into the view.

In one form, a system for displaying messages to a spectator attending an event at a venue, comprises a positioning system for dynamically determining the position of participants at the venue. The system includes a radio network for transmitting the position of said participants as they change and a server which receives said transmitted participant positions. A spectator uses a spectator device operable to receive said participant positions from said server. The spectator device has a graphics display and is operable by the spectator to select a spectator viewing location proximate to said venue for viewing said venue in a perspective view from said spectator viewing location. A geo-referenced, artificial reality message is inserted into said perspective view and said message is enhanced.

In one embodiment, a method for viewing messages at a venue, comprises determining a position of one or more participants at the venue and transmitting the position of a participant. A spectator is equipped with a computer, such as a smart phone, having a graphics display. The participant position is communicated to the spectator, who views on the graphics display the participant position at the venue in a perspective view. The method inserts an artificial reality message into the perspective view of the venue, wherein the message presentation is enhanced when the perspective view changes at the venue from a first view to a second view.

### BRIEF DESCRIPTION OF THE DRAWINGS

FIG. 1 is a perspective view of a race track with a car in the foreground from a viewing position of a spectator in attendance;

FIG. 2 is another perspective view of the race track of FIG. 1 from the position of a spectator, where a sign on the fence and logo on the car is difficult to discern;

FIG. 3 is a perspective view similar to FIG. 2 where the sign on the fence is enhanced relative to the spectator's perspective view;

FIG. 4 is a perspective view of a race car abeam a spectator viewing location;

FIG. 5 is a perspective view from the spectator position of FIG. 4 where the sign on the advertisement message on the car is enhanced relative to the spectator's perspective view and an artificial reality message is inserted on the track;

FIG. 6 is a perspective view of a golf hole from a selected spectator location;

FIG. 7 is a perspective view of a slalom ski course from a selected spectator location;

FIG. 8 is a block diagram depicting a wireless, client server architecture in accordance with a preferred embodiment of the present invention; and

FIG. 9 is a front elevation view of a smart phone having a graphics display.

### DETAILED DESCRIPTION

High bandwidth, wireless networks are becoming commonplace, as is the computing power of mobile devices. Further rendering engines are becoming readily available for wide ranging applications of artificial reality. Viewing an event, such as a sporting event, using a mobile device adds greatly to the user experience. U.S. Pat. No. 7,855,638 describes several examples of a system and method for viewing such events. In such event viewing systems, the background can be a real world image or a virtual world rendering, but in any preferred cases, artificial reality is used to enhance the viewing experience.

In creating such environments for the venue of the event, it is desirable to insert virtual objects into the environment, such as an advertising message. Several difficulties result with such message placement, caused primarily by the moving sports participants and the possibility the spectator may change the origin of the spectator's viewpoint. That is, if a message is geographically affixed to a moving participant or if the message is at a fixed location at the venue, comprehension of the message is often difficult, in part, because of the viewing angle between the spectator's location and geographically fixed message.

The present system and methods address this problem by enhancing the discernability of any message inserted into the viewing of the event. That is, the message is preferably altered for clarity or enhanced by changing the presentation of the message. In one form, the orientation of the message can be altered so that the message is oriented for reading by the spectator from the selected viewing location. In another form, the perspective of the alpha numeric message can be changed, or even the font used. Other enhancements include a change to the lighting, color, or background of the message.

The present system and methods also address the problem of determining the content of a message and also product placement into the viewing of the event, such that a message or product inserted into the viewing of the event is more relevant to the spectator. In many cases, the content or product placement is determined by the event itself, e.g., at a NASCAR event an advertisement that is likely appealing to NASCAR fans is inserted. In other cases, the context of the advertisement or product placement might be determined by the personal information of the individual spectator as gleaned from the spectator's viewing device, social media or cloud based data.

In the present application, the term “message” is used to describe advertisements, facts, event information, warnings, announcements and other types of alpha numeric displays. However, the message could also be a logo or brand. It shall be understood that other objects or graphics may also be enhanced and the term “message” is understood to include other objects.

The most common positioning technology is GPS. As used herein, GPS—sometimes known as GNSS—is meant to include all of the current and future positioning systems that include satellites, such as the U.S. Navistar, GLONASS, Galileo, EGNOS, WAAS, MSAS, QZSS, etc. The accuracy of the positions, particularly of the participants, can be improved using known techniques, often called differential techniques, such as WAAS (wide area), LAAS (local area), Carrier-Phase Enhancement (CPGPS), Space Based Augmentation Systems (SBAS); Wide Area GPS Enhancement (WAGE), or Relative Kinematic Positioning (RKP). Even without differential correction, numerous improvements are increasing GPS accuracy, such as the increase in the satellite constellation, multiple frequencies (L₁, L₂, L₅), modeling and AGPS improvements, software receivers, and ground station improvements. Of course, the positional degree of accuracy is driven by the requirements of the application. In the NASCAR example used to illustrate a preferred embodiment, two meter accuracy provided by WAAS would normally be acceptable. Further, many “events” might be held indoors and the same message enhancement techniques described herein used. Such indoor positioning systems include IMEO, Wi-Ri (Skyhook), Cell ID, pseudolites, repeaters, RSS on any electromagnetic signal (e.g. TV) and others known or developed.

The term “geo-referenced” means a message fixed to a particular location or object. Thus, the message might be fixed to a venue location, e.g., race track fence or fixed to a moving participant, e.g., a moving race car. An object is typically geo-referenced using either a positioning technology, such as GPS, but can also be geo-referenced using machine vision. If machine vision is used, applications can be “markerless” or use “markers,” sometimes known as “fiducials.” Marker-based augmented reality often uses a square marker with a high contrast. In this case, four corner points of a square are detected by machine vision using the square marker and three-dimensional camera information is computed using this information. Other detectable sources have also been used, such as embedded LED's or special coatings or QR codes. Applying AR to a marker which is easily detected is advantageous in that recognition and tracking are relatively accurate, even if performed in real time. So, in applications where precise registration of the AR message in the background environment is important, a marker based system can be advantageous.

In a “markerless” system, AR uses a general natural image instead of a fiducial. In general, markerless AR use a feature point matching method. Feature point matching refers to an operation for searching for and connecting the same feature points in two different images. A method for extracting a plane using a Simultaneous Localization and Map-building (SLAM)/Parallel Tracking And Mapping (PTAM) algorithm for tracking three-dimensional positional information of a camera and three-dimensional positional information of feature points in real time and providing AR using the plane has been suggested. However, since the SLAM/PTAM algorithm acquires the image so as to search for the feature points, computes the three-dimensional position of the camera and the three-dimensional positions of the feature points, and provides AR based on such information, a considerable computation is necessary. A hybrid system can also be used where a readily recognized symbol or brand is geo-referenced and machine vision substitutes the AR message.

In the present application, the venue for the event can be a real environment or a virtual environment, or a mixture, sometimes referred to as “mixed reality.” A convenient way of understanding the messages of the present invention is as a layer of artificial reality or “augmented reality” overlaid the environment. There are different methods of creating this environment as understood by one of ordinary skill in the art. For example, an artificial background environment can be created by a number of rendering engines, sometimes known as a “virtual” environment. See, e.g., Nokia's (through its Navteq subsidiary) Journey View which blends digital images of a real environment with an artificial 3D rendering. A real environment is most easily created using a digital image. Such a digital image can be stored and retrieved for use, such as a “street view” or other type of stored image. Alternatively, many mobile devices have a camera for capturing a digital image which can be used as the background environment. Such a camera-sourced digital image may come from the user, friends, crowd-sourced, or service provided. Because the use of a real environment as the background is common, “augmented reality” (AR) often refers to a technology of inserting a virtual reality graphic (object) into an actual digital image and generating an image in which a real object and a virtual object are mixed (i.e. “mixed reality”). AR is characterized in that supplementary information using a virtual graphic may be layered or provided onto an image acquired of the real world. Multiple layers of real and virtual reality can be mixed. In such applications the placement of an object or “registration” with other layers is important. That is, the position of objects relative to each other based on a positioning system should be close enough to support the application. As used herein, “artificial reality” is sometimes used interchangeably with “mixed” or “augmented” reality, it being understood that the background environment can be real or virtual.

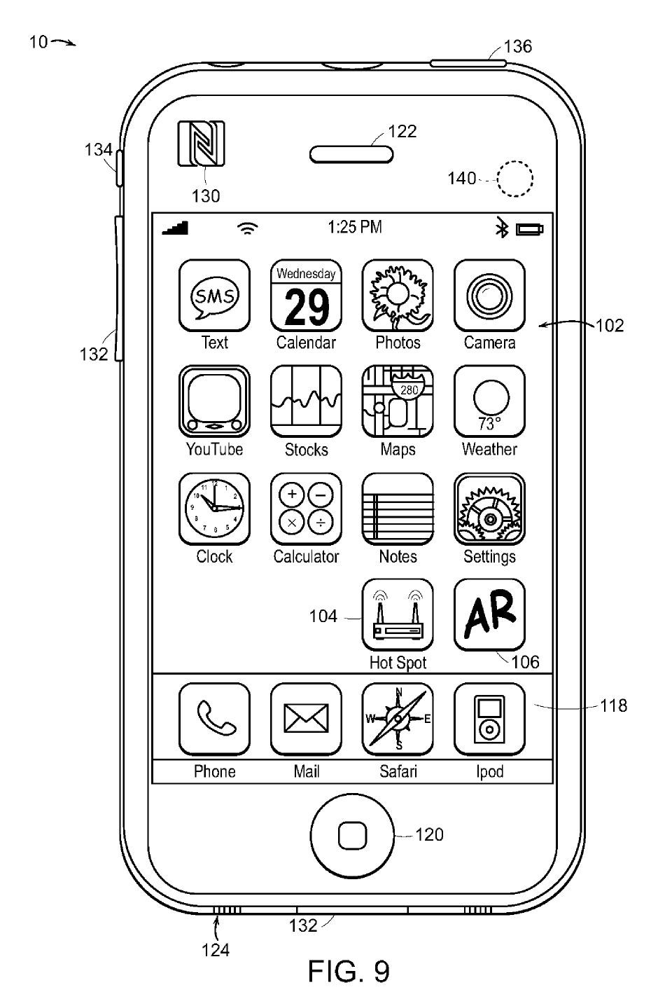

Turning to the drawings, an illustrative embodiment uses a mobile device, such as the smart phone 10 of FIG. 9, accompanying a spectator to an event. In the illustrated embodiment, the event is a NASCAR race. The spectator selects the AR application 106 on the touch sensitive graphics display 102. The smart phone 10 includes a variety of sensors, including a GPS unit for determining its location, an accelerometer for determining the orientation, a gyroscope, ambient light sensor and a digital compass. Additionally, the phone 10 includes one or more radios, such as a packet radio, a cell radio, WiFi, Bluetooth, and near field.

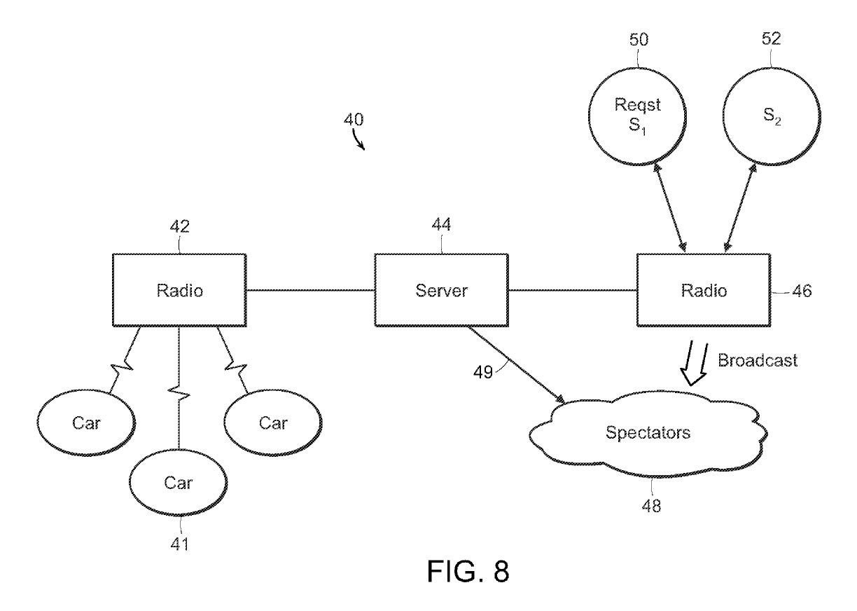

FIG. 8 illustrates the typical network 40 for the NASCAR race example. Each participant (car) 41 is equipped with a positioning mechanism, such as GPS which is transmitted by radio to a radio 42 connected to a server 44. The GPS derived position can be corrected and accuracy improved if desired, such as currently done with F1 racing. The participant positions are transmitted by radio 46 to the spectators 48. That is, each spectator 48 has a smart phone 10 for receiving the transmitted participant positions. Of course, the server 44 can also transmit spectator position information to remote or home users via Internet connection 49. Such home spectators can, if desired, call up a subscreen (PIP) on their TV while watching a TV broadcast of the NASCAR race to enhance their TV viewing experience, or alternatively, watch the event on a home computer or other device.

### Mobile Device

In more detail, FIG. 9 is a front elevational view of a smart phone 10, which is the preferred form factor for the device in the NASCAR race application discussed herein to illustrate certain aspects of the present invention. The mobile device 10 can be, for example, a handheld computer, a tablet computer, a personal digital assistant, a cellular telephone, a network appliance, a camera, a smart phone, an enhanced general packet radio service (EGPRS) mobile phone, a network base station, a media player, a navigation device, an email device, a game console, or other electronic device or a combination of any two or more of these data processing devices or other data processing.

The mobile device 10 includes a touch-sensitive graphics display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

The touch-sensitive graphics display 102 can comprise a multi-touch-sensitive display. A multi-touch-sensitive display 102 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device. An example of a multi-touch-sensitive display technology is described in U.S. Pat. Nos. 6,323,846; 6,570,557; 6,677,932; and U.S. Publication No. 2002/0015024, each of which is incorporated by reference herein in its entirety. The touch screen 102 and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen display 102.

The mobile device 10 can display one or more graphical user interfaces on the touch-sensitive display 102 for providing the user access to various system objects and for conveying information to the user. The graphical user interface can include one or more display objects 104, 106. Each of the display objects 104, 106 can be a graphic representation of a system object. Some examples of system objects include device functions, applications, windows, files, alerts, events, or other identifiable system objects.

The mobile device 10 can implement multiple device functionalities, such as a telephony device, as indicated by a phone object; an e-mail device, as indicated by the e-mail object; a network data communication device, as indicated by the Web object; a Wi-Fi base station device (not shown); and a media processing device, as indicated by the media player object. For convenience, the device objects, e.g., the phone object, the e-mail object, the Web object, and the media player object, can be displayed in a menu bar 118.

Each of the device functionalities can be accessed from a top-level graphical user interface, such as the graphical user interface illustrated in FIG. 9. Touching one of the objects e.g. 104, 106, etc. can, for example, invoke the corresponding functionality. In the illustrated embodiment, object 106 represents an Artificial Reality application in accordance with the present invention.

Upon invocation of particular device functionality, the graphical user interface of the mobile device 10 changes, or is augmented or replaced with another user interface or user interface elements, to facilitate user access to particular functions associated with the corresponding device functionality. For example, in response to a user touching the phone object, the graphical user interface of the touch-sensitive display 102 may present display objects related to various phone functions; likewise, touching of the email object may cause the graphical user interface to present display objects related to various e-mail functions; touching the Web object may cause the graphical user interface to present display objects related to various Web-surfing functions; and touching the media player object may cause the graphical user interface to present display objects related to various media processing functions.

The top-level graphical user interface environment or state of FIG. 9 can be restored by pressing a button 120 located near the bottom of the mobile device 10. Each corresponding device functionality may have corresponding “home” display objects displayed on the touch-sensitive display 102, and the graphical user interface environment of FIG. 9 can be restored by pressing the “home” display object.

The top-level graphical user interface is shown in FIG. 9 and can include additional display objects, such as a short messaging service (SMS) object, a calendar object, a photos object, a camera object, a calculator object, a stocks object, a weather object, a maps object, a notes object, a clock object, an address book object, and a settings object, as well as the AR object 106. Touching the SMS display object can, for example, invoke an SMS messaging environment and supporting functionality. Likewise, each selection of a display object can invoke a corresponding object environment and functionality.

The mobile device 10 can include one or more input/output (I/O) devices and/or sensor devices. For example, a speaker 122 and a microphone 124 can be included to facilitate voice-enabled functionalities, such as phone and voice mail functions. In some implementations, a loud speaker 122 can be included to facilitate hands-free voice functionalities, such as speaker phone functions. An audio jack can also be included for use of headphones and/or a microphone.

A proximity sensor (not shown) can be included to facilitate the detection of the user positioning the mobile device 10 proximate to the user's ear and, in response, to disengage the touch-sensitive display 102 to prevent accidental function invocations. In some implementations, the touch-sensitive display 102 can be turned off to conserve additional power when the mobile device 10 is proximate to the user's ear.

Other sensors can also be used. For example, an ambient light sensor (not shown) can be utilized to facilitate adjusting the brightness of the touch-sensitive display 102. An accelerometer (not shown) can be utilized to detect movement of the mobile device 10, as indicated by the directional arrow. Accordingly, display objects and/or media can be presented according to a detected orientation, e.g., portrait or landscape.

The mobile device 10 may include circuitry and sensors for supporting a location determining capability, such as that provided by the global positioning system (GPS) or other positioning system (e.g., Cell ID, systems using Wi-Fi access points, television signals, cellular grids, Uniform Resource Locators (URLs)). A positioning system (e.g., a GPS receiver) can be integrated into the mobile device 10 or provided as a separate device that can be coupled to the mobile device 10 through an interface (e.g., port device 132) to provide access to location-based services.

The mobile device 10 can also include a camera lens and sensor 140. In some implementations, another camera lens and sensor can be located on the back surface of the mobile device 10. The cameras can capture still images and/or video. The camera subsystem and optical sensor 140, may comprise, e.g., a charged coupled device (CCD) or a complementary metal-oxide semiconductor (CMOS) optical sensor, can be utilized to facilitate camera functions, such as recording photographs and video clips.

The preferred mobile device 10 includes a GPS positioning system. In this configuration, another positioning system can be provided by a separate device coupled to the mobile device 10, or can be provided internal to the mobile device. Such a positioning system can employ positioning technology including a GPS, a cellular grid, URL's, IMEO, pseudolites, repeaters, Wi-Fi or any other technology for determining the geographic location of a device. The positioning system can employ a service provided by a positioning service such as, for example, a Wi-Fi RSS system from SkyHook Wireless of Boston, Mass., or Rosum Corporation of Mountain View, Calif. In other implementations, the positioning system can be provided by an accelerometer and a compass using dead reckoning techniques starting from a known (e.g. determined by GPS) location. In such implementations, the user can occasionally reset the positioning system by marking the mobile device's presence at a known location (e.g., a landmark or intersection). In still other implementations, the user can enter a set of position coordinates (e.g., latitude, longitude) for the mobile device. For example, the position coordinates can be typed into the phone (e.g., using a virtual keyboard) or selected by touching a point on a map. Position coordinates can also be acquired from another device (e.g., a car navigation system) by syncing or linking with the other device. In other implementations, the positioning system can be provided by using wireless signal strength and one or more locations of known wireless signal sources (Wi-Fi, TV, FM) to provide the current location. Wireless signal sources can include access points and/or cellular towers. Other techniques to determine a current location of the mobile device 10 can be used and other configurations of the positioning system are possible.

The mobile device 10 can also include one or more wireless communication subsystems, such as a 802.11b/g/n communication device, and/or a Bluetooth™ communication device, in addition to near field communications. Other communication protocols can also be supported, including other 802.x communication protocols (e.g., WiMax, Wi-Fi), code division multiple access (CDMA), global system for mobile communications (GSM), Enhanced Data GSM Environment (EDGE), 3G (e.g., EV-DO, UMTS, HSDPA), etc. Additional sensors are incorporated into the device 10, such as accelerometer, digital compass and gyroscope. Further, peripheral sensors, devices and subsystems can be coupled to the peripherals interface 132 to facilitate multiple functionalities. For example, a motion sensor, a light sensor, and a proximity sensor can be coupled to the peripherals interface 132 to facilitate the orientation, lighting and proximity functions described with respect to FIG. 9. Other sensors can also be connected to the peripherals interface 132, such as a GPS receiver, a temperature sensor, a biometric sensor, or other sensing device, to facilitate related functionalities.

The port device 132, is e.g., a Universal Serial Bus (USB) port, or a docking port, or some other wired port connection. The port device 132 can, for example, be utilized to establish a wired connection to other computing devices, such as other communication devices 10, a personal computer, a printer, or other processing devices capable of receiving and/or transmitting data. In some implementations, the port device 132 allows the mobile device 10 to synchronize with a host device using one or more protocols.

Input/output and operational buttons are shown at 132-136 to control the operation of the device 10 in addition to, or in lieu of the touch sensitive screen 102. The mobile device 10 can include a memory interface to one or more data processors, image processors and/or central processing units, and a peripherals interface. The memory interface, the one or more processors and/or the peripherals interface can be separate components or can be integrated in one or more integrated circuits. The various components in the mobile device 10 can be coupled by one or more communication buses or signal lines.

Preferably, the mobile device includes a graphics processing unit (GPU) coupled to the CPU. While a Nvidia GeForce GPU is preferred, in part because of the availability of CUDA, any GPU compatible with OpenGL is acceptable. Tools available from Kronos allow for rapid development of 3D models.

The I/O subsystem can include a touch screen controller and/or other input controller(s). The touch-screen controller can be coupled to a touch screen 102. The other input controller(s) can be coupled to other input/control devices 132-136, such as one or more buttons, rocker switches, thumb-wheel, infrared port, USB port, and/or a pointer device such as a stylus. The one or more buttons (132-136) can include an up/down button for volume control of the speaker 122 and/or the microphone 124.

In one implementation, a pressing of the button 136 for a first duration may disengage a lock of the touch screen 102; and a pressing of the button for a second duration that is longer than the first duration may turn power to the mobile device 10 on or off. The user may be able to customize a functionality of one or more of the buttons. The touch screen 102 can, for example, also be used to implement virtual or soft buttons and/or a keyboard.

In some implementations, the mobile device 10 can present recorded audio and/or video files, such as MP3, AAC, and MPEG files. In some implementations, the mobile device 10 can include the functionality of an MP3 player, such as an iPod™. The mobile device 10 may, therefore, include a 36-pin connector that is compatible with the iPod. Other input/output and control devices can also be used.

The memory interface can be coupled to a memory. The memory can include high-speed random access memory and/or non-volatile memory, such as one or more magnetic disk storage devices, one or more optical storage devices, and/or flash memory (e.g., NAND, NOR). The memory can store an operating system, such as Darwin, RTXC, LINUX, UNIX, OS X, WINDOWS, or an embedded operating system such as VxWorks. The operating system may include instructions for handling basic system services and for performing hardware dependent tasks. In some implementations, the operating system handles timekeeping tasks, including maintaining the date and time (e.g., a clock) on the mobile device 10. In some implementations, the operating system can be a kernel (e.g., UNIX kernel).

The memory may also store communication instructions to facilitate communicating with one or more additional devices, one or more computers and/or one or more servers. The memory may include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/Navigation instructions to facilitate GPS and navigation-related processes and instructions; camera instructions to facilitate camera-related processes and functions; other software instructions to facilitate other related processes and functions; and/or diagnostic instructions to facilitate diagnostic processes and functions. The memory can also store data, including but not limited to documents, images, video files, audio files, and other data.

### Network Operating Environment

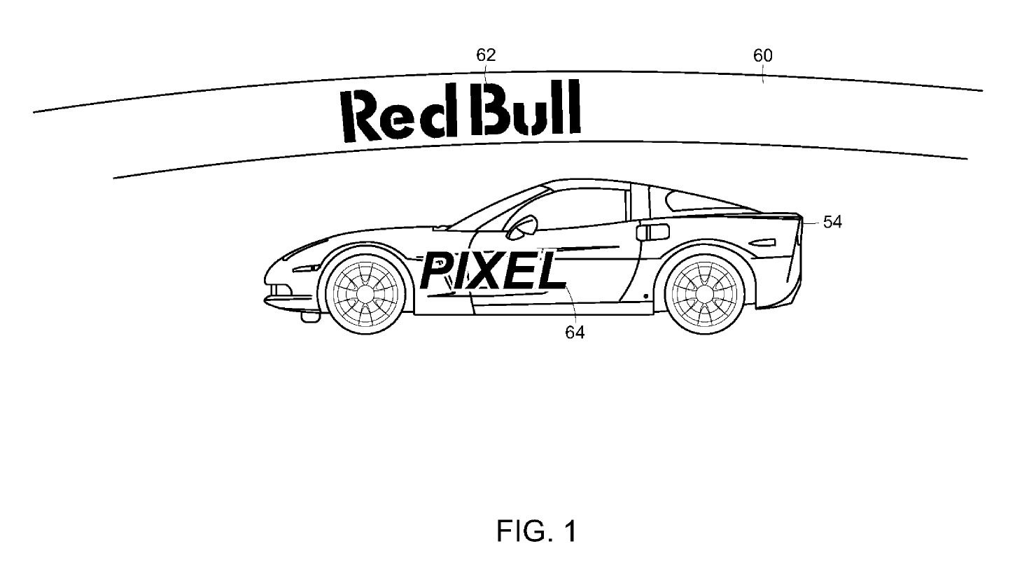

In FIG. 8, a depiction of the network 40 is shown. The cars 41 communicate with a radio base station 42 preferably using spread spectrum radio (encrypted or secured if desired). A spread spectrum radio such as made by Freewave Technologies of Boulder, Colo. is a preferred choice (e.g. a 900 MHz board level module or SOC). The server 44 stores the position data of each car 41 communicated to the base station 42, and other pertinent data such as car sensor data, etc. Ideally, the server 44 can also digitally store the voice communications of interest (e.g. pit to driver) and video clips of various scenes of possible interest. Of course, the server 44 can store advertising messages as well for delivery to spectators. The server 44 can also be used for authentication of graphic devices 10 and enable selectable purchases from spectators (i.e. refreshments or memorabilia for delivery). The server 44 can also process the incoming position data to increase the accuracy if desired. For example, the server 44 can include its own base station GPS and apply a correction to a participant's position if desired. In some applications, the participants might broadcast location information directly to spectators, i.e. without an intervening server. The radio 46 is used to communicate on a broadcast basis to all spectators 48 in attendance—here using WiFi, the GPS position information of the cars 41 (or car objects, encrypted or secured if desired). The devices 10 in the hands of the spectators 48 processes the position information to render the views illustrated for example in FIGS. 1-7. While radio 46 preferably uses WiFi (802.11b/g/n) to transmit, 4G cellular networks such as LTE, or Long Term Evolution, have download speeds (e.g. 12 mbps) surpassing WiFi and may become acceptable substitutes. For example, WiMax (Sprint>10 mbps); LTE (Verizon 40-50 mbps) (AT&T unknown); and HSPA+(T mobile 21 mbps) (AT&T 16 mbps) appear acceptable 4G network speeds. In many cases, with high performance 4G cellular networks the local server 44 and network of FIG. 8 can be eliminated and the 4G network used.

Special requests from spectators 48 can be made to the server 44, such as for streaming video of a particular scene or audio of a particular car 41, refreshment orders, memorabilia purchases, etc. This function is shown at 50, 52 in FIG. 8.

Some spectators 48 may be remote from the sporting event. In this case, the server 44 can transmit the desired information over the internet connection 49 to the home computer or television remote from the event. While one embodiment has been described in the context of a spectator in physical attendance at a sporting event with information broadcast by radio, the use of the graphic devices 10 at remote locations is equally feasible. In another embodiment more suited for remote locations, for example, the portable device 10 can be used at home while watching a sporting event on TV, with the participant location and other information streaming over the internet. WiFi in the home is a preferred mode of broadcasting the information between the portable device and the network.

Using graphic device 10 at home while watching the same sporting event on TV is believed to be a preferred embodiment for use at remote locations. However, other examples of remote location of a sporting event viewing might not be accompanied by watching TV. That is, the views of FIGS. 1-7 can be accomplished using any graphic device, including a personal computer, tablet, or a cell phone. Similar to using the graphic device 10 coupled to the internet, a personal computer user can select the source or position of origination of the desired view, and the target or orientation from the source or target. Elevations, zoom, pan, tilt, etc. may be selected by a remote user as desired to change the origin viewpoint or size.

In “my view,” for example, the remote location graphic device might display only information to the 3rd turn spectator for cars nearest the 3rd turn. Alternatively, the remote location spectator might want to follow a particular car continuously, e.g. follow car number 8 (or particular golfer, etc.), with selectable views (overheard, turns, stands, head, driver's view). In any of these modes, the remote location spectator could zoom, pan or tilt as described above, freeze, slow motion, replay, etc. to obtain a selected view on the graphic device.

While the preferred embodiment contemplates most processing occurring at device 10, different amounts of preprocessing of the position data can be processed at the server 44. For example, the participant information can be differentially corrected at the server (e.g. in addition to WAAS or a local area differential correction) or at device 10 or even information post-processed with carrier phase differential to achieve centimeter accuracy. Further, it is anticipated that most of the graphics rendering can be accomplished at the portable device 10, but an engineering choice would be to preprocesses some of the location and rendering information at the server 44 prior to broadcast. In particular, many smart phones and handheld computers include GPU's which enable photorealistic rendering and the developers have access to advanced tools for development such as OpenGL and CUDA.

The mobile device 10 of FIG. 9 preferably accompanies some of the spectators 48 of FIG. 8 in attendance at the event. The devices 10 communicate over one or more wired and/or wireless networks 46 in data communication with server 44. In addition, the devices can communicate with a wireless network, e.g., a cellular network, or communicate with a wide area network (WAN), such as the Internet, by use of a gateway. Likewise, an access point associated with Radio 46, such as an 802.11b/g/n wireless access point, can provide communication access to a wide area network.

Both voice and data communications can be established over the wireless network of FIG. 8 and the access point 46 or using a cellular network. For example, the mobile device 10 a can place and receive phone calls (e.g., using VoIP protocols), send and receive e-mail messages (e.g., using POP3 protocol), and retrieve electronic documents and/or streams, such as web pages, photographs, and videos, over the wireless network, gateway, and wide area network (e.g., using TCP/IP or UDP protocols). Likewise, the mobile device 10 can place and receive phone calls, send and receive e-mail messages, and retrieve electronic documents over the access point 46 and the wide area network. In some implementations, the mobile device 10 can be physically connected to the access point 46 using one or more cables and the access point 218 can be a personal computer. In this configuration, the mobile device 10 can be referred to as a “tethered” device.

The mobile devices 10 can also establish communications by other means. For example, the wireless device 10 a can communicate with other wireless devices, e.g., other wireless devices 10, cell phones, etc., over a wireless network. Likewise, the mobile devices 10 can establish peer-to-peer communications, e.g., a personal area network, by use of one or more communication subsystems, such as the Bluetooth™ communication device. Other communication protocols and topologies can also be implemented.

In the NASCAR example, it is believed preferable to use a virtual environment as the background. In other sports it is preferable to use a real environment, such as a digital image. Therefore, the server 44 preferably uses the OTOY, Gaikai, or OnLive video compression technology to transmit the participant position information the virtual background environment, as well as the AR objects, such as each car 54. OTOY (and Gaikai and OnLive) are cloud based gaming and application vendors that can transmit real time photorealistic gaming to remote gamers. Such companies that render photorealistic 3D games for realtime remote play are Otoy, see, e.g., www.otoy.com; OnLive, see, e.g., en.wikipedia.org/wiki/OnLive; and Gaikai, see, e.g., technabob.com/blog/2010/03/16/gaikai-cloud-based-gaming. Onlive, for example, advertises that with 5 mbps it can transfer 220 frames per second with 12-17 ms latency, employed advanced graphics—ajax, flash, Java, ActiveX.

The goal is high performance game systems that are hardware and software agnostic. That is, a goal is intense game processing performed on a remote server and communicated to the remote user. Using such cloud based gaming technology, the smart phones 10 can run any of the advanced browsers (e.g. IE9 or Chrome) running HTML5 that support 3D graphics. However, other AR specific browsers can alternatively be used, such as available from Layar, Junaio, Wikitude, Sekai Camera or Mixare (www.mixare.org). While OTOY (and Gaikai and OnLive) promise no discernable latency in their gaming environment, the server 44 for the race car event of FIG. 8 is preferably placed at the venue of the event.

Therefore, the amount of processing occurring at the server 44 versus the device 10 is a design choice based on the event, the background, the radio network available, the computational and display capability available at the device 10 or other factors.

FIG. 1 illustrates the perspective view of a spectator 48 on the device 10 as the car 54 is abeam the spectator's chosen location. In many circumstances, the spectator chooses “my location” for viewing the sporting event. In this case, the GPS in the device 10 uses its location as the origin of the spectator's perspective view. Alternatively, the spectator may choose a different location as the origin for the view, such as overhead or finish line. In FIG. 1, the track fence 60 includes an advertising message 62. The message 62 is geo-referenced to the track fence location. The car 54 also includes a message 64 that is geo-referenced to the side of the moving car 54.

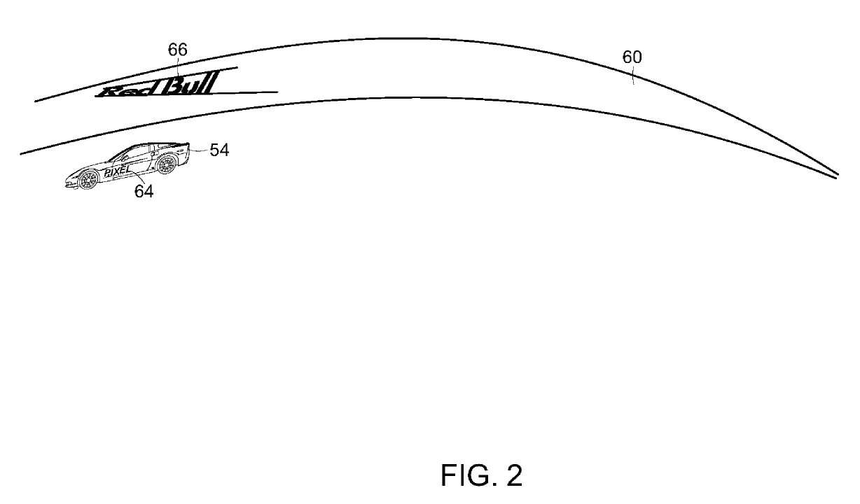

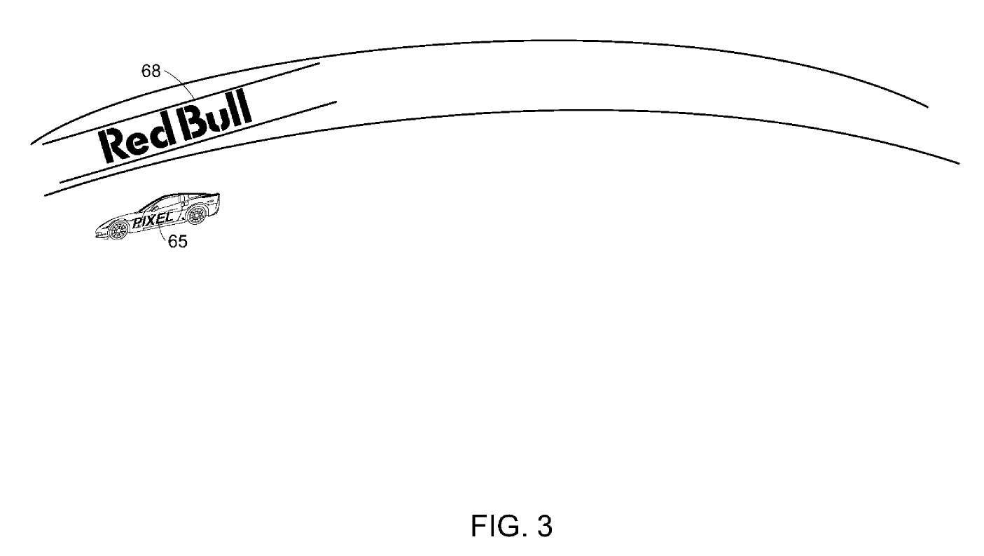

FIG. 2 is a view of the car 54 from the same location as shown in FIG. 1. However, in FIG. 2 the car 54 has traveled down the race track and another message 66 on the fence 60 and message 64 on the car 54 are not as easily discerned. FIG. 3 is similar to FIG. 2. The view origin is the same—the position of the spectator 48 has not changed. However, the message 68 is now an enhanced version of the message 66 of FIG. 2, and similarly, message 65 is an enhanced form of message 64. In FIG. 3 the message 68 has a change of perspective to make the message more discernable to the spectator location, which is the view origin.

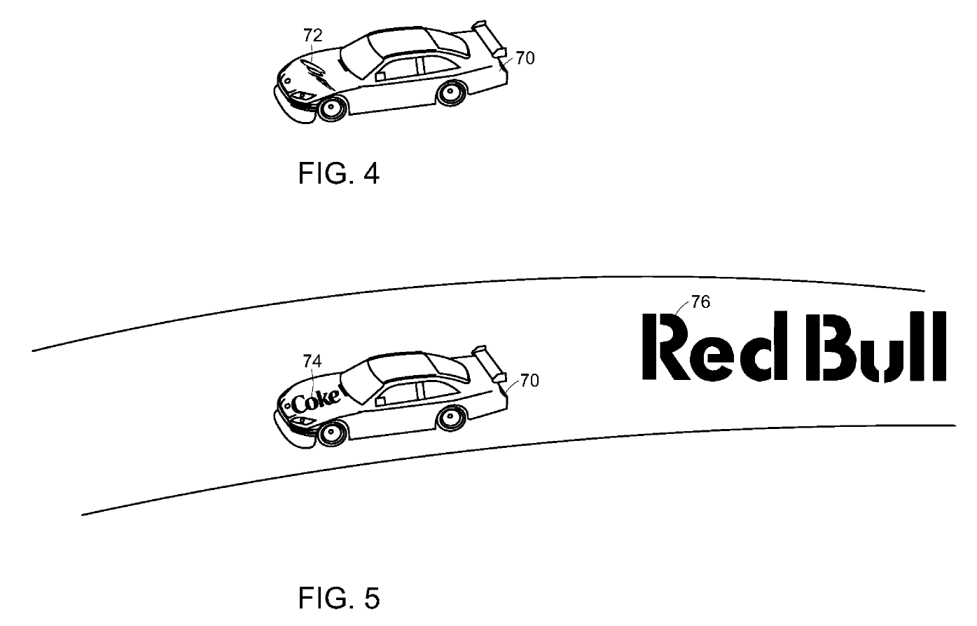

FIG. 4 illustrates a perspective view of car 70 proximate a spectator selected view origin. The car 70 includes an advertising message 72 on its hood. FIG. 5 is identical to FIG. 4 except the advertising message 74 is enhanced. That is, the font and size of the alphanumeric characters is changed and the type is enlarged and oriented for ease of view by the spectator 48. Additionally, FIG. 5 illustrates the virtual placement of an ad 76 on the race track. Such an ad 76 can be geo-referenced to a certain track location, or it can follow the moving car 70 on the track during the race.

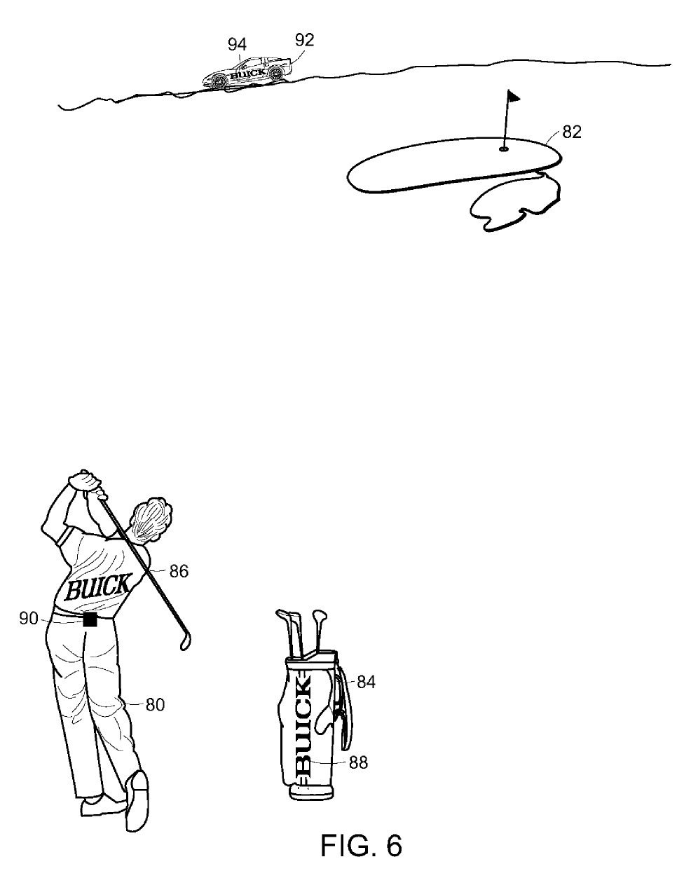

FIG. 6 is another example in the context of a golf event. In this case, a player 80 is shooting to the green 82 and accompanied by his golf bag 84. Note that the player 80 might be a professional golfer and the spectator is viewing the play of a professional golf round. However, the golfer 80 might be the user and the user is simply replaying his round at a later date on a home computing device.

Golfer 80 includes an ad message 86 on his shirt back. Additionally, ad message 88 is inserted on the bag 84. Alternatives are possible for the placement of the ads, so the message 86 is geo-referenced to the position of the player 80 using GPS. That is, the player 80 wears a GPS unit 90 on his waist and the ad message 86 is inserted into an AR layer just above the GPS position. Meanwhile the bag uses a marker such as an LED on the bag 84 for proper ad message 88 registration.

FIG. 6 also illustrates a product insert into the AR layer. In FIG. 6 car 92 is inserted into the display in the AR layer. On the car object 92, an ad message 94 is inserted. Such product placement can occur at convenient geo-referenced locations on the golf course.

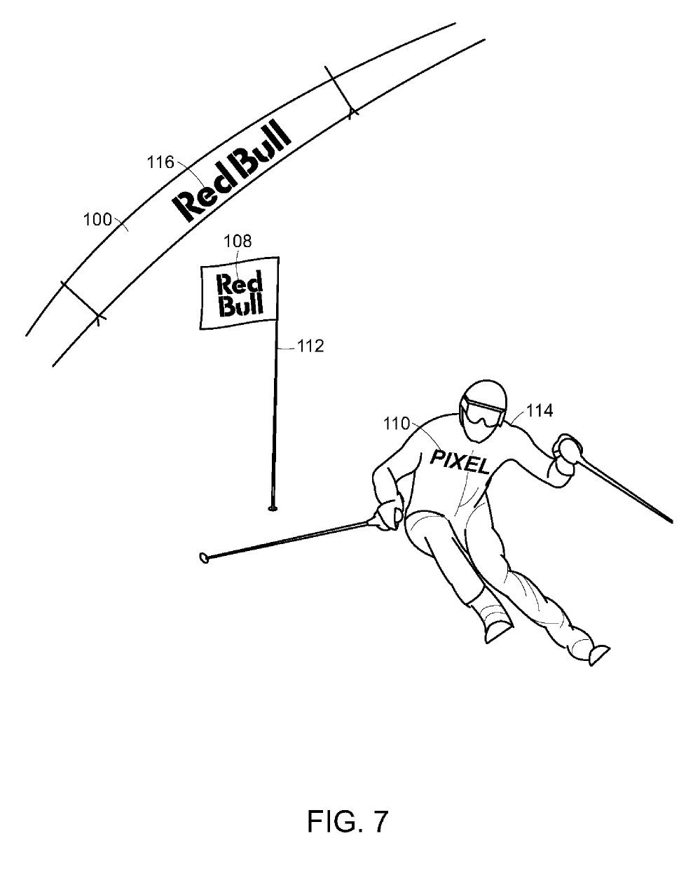

FIG. 7 illustrates yet another type of sporting event, in the this case a downhill slalom course having a boundary fence 100 and gate markers 112. Skier 114 is viewed transiting the course. In FIG. 7, the messages 116, 108 are illustrated as geo-referenced to the fence 100 and gate 112 respectively. The messages 116, 108 are inserted with a discernable perspective from the view origin which is downhill from the skier 114 in the drawing. The ad message 110 on the skier 114 is preferably exactly registered on the ski bib. In this case the skier has a GPS embedded in his helmet (not shown), so the skier object in the AR layer is shown traversing the course. The skier object includes the message 110 on the ski bib.

In FIG. 7, for example the background environment might be a real environment as taken by the camera in device 10. That is, the spectator 48 takes a digital image using device 10 which constitutes the background environment and the skier progresses down the slope. An AR layer is inserted onto the real background and skier comprising messages 116, 108, 110. An AR marker (e.g. an LED) is placed on the ski bib for more exact registration of the message 110 with the skier 114 as the skier moves down the slope. As illustrated, the message 110 is enhanced, e.g. reoriented for better viewing as the skier participates in the event.

As illustrated in the drawings, the messages can be “enhanced” for better presentation to the spectator. Such enhancements include the perspective of the message, the font used, the font size, and the font and background color and contrast. Further, the message can be reoriented for better recognition by the spectator.

In addition the content of the advertisement messages can be changed based on context. Such smart phones 10 have not only machine ID's, but also search history, location history, and even personal information. Further, the user might be identified based on social media participation—e.g. Facebook or Twitter accounts. Such information is considered “context” in the present application, along with the typical demographics of an event and “marketing factors” as previously discussed. That is, the event might have its own context which indicates the demographic profile of most of the spectators at the event. A golf match might have a context of golf spectators with adequate disposable income to purchase a vehicle. Therefore, advertising Buick as shown in FIG. 6 makes sense. Particularly if the event is a concert or political rally a context can be more accurately postulated.

### Graphics

The graphics generated on the screen 102 can be 2D graphics, such as geometric models (also called vector graphics) or digital images (also called raster graphics). In 2D graphics, these components can be modified and manipulated by two-dimensional geometric transformations such as translation, rotation, scaling. In object oriented graphics, the image is described indirectly by an object endowed with a self-rendering method—a procedure which assigns colors to the image pixels by an arbitrary algorithm. Complex models can be built by combining simpler objects, in the paradigms of object-oriented programming. Modern computer graphics card displays almost overwhelmingly use raster techniques, dividing the screen into a rectangular grid of pixels, due to the relatively low cost of raster-based video hardware as compared with vector graphic hardware. Most graphic hardware has internal support for blitting operations and sprite drawing.

Preferably, however, the graphics generated on screen 102 are 3D. OpenGL and Direct3D are two popular APIs for the generation of real-time imagery in 3D. Real-time means that image generation occurs in “real time” or “on the fly”). Many modern graphics cards provide some degree of hardware acceleration based on these APIs, frequently enabling the display of complex 3D graphics in real-time. However, it's not necessary to employ any one of these to actually create 3D imagery. The graphics pipeline technology is advancing dramatically, mainly driven by gaming applications enabling more realistic 3D synthetic renderings of FIGS. 1-5.

3D graphics have become so popular, particularly in computer games, that specialized APIs (application programmer interfaces) have been created to ease the processes in all stages of computer graphics generation. These APIs have also proved vital to computer graphics hardware manufacturers, as they provide a way for programmers to access the hardware in an abstract way, while still taking advantage of the special hardware of this-or-that graphics card.

These APIs for 3D computer graphics are particularly popular:
OpenGL and the OpenGL Shading Language

OpenGL ES 3D API for embedded devices

Direct3D (a subset of DirectX)

RenderMan

RenderWare

Glide API

TruDimension LC Glasses and 3D monitor API

OpenGL is widely used and many tools are available from firms such as Kronos. There are also higher-level 3D scene-graph APIs which provide additional functionality on top of the lower-level rendering API. Such libraries under active development include:

QSDK

Quesa

Java 3D

JSR 184 (M3G)

NVidia Scene Graph

OpenSceneGraph

OpenSG

OGRE

Irrlicht

Hoops3D

Photo-realistic image quality is often the desired outcome, and to this end several different, and often specialized, rendering methods have been developed. These range from the distinctly non-realistic wireframe rendering through polygon-based rendering, to more advanced techniques such as: scanline rendering, ray tracing, or radiosity. The rendering process is computationally expensive, given the complex variety of physical processes being simulated. Computer processing power has increased rapidly over the years, allowing for a progressively higher degree of realistic rendering. Film studios that produce computer-generated animations typically make use of a render farm to generate images in a timely manner. However, falling hardware costs mean that it is entirely possible to create small amounts of 3D animation on a small processor, such as in the device 10. Driven by the game studios, hardware manufacturers such as ATI, Nvidia, Creative Labs, and Ageia have developed graphics accelerators which greatly increase the 3D rendering capability. It can be anticipated that in the future, one or more graphics rendering chips, such as the Ageia Physx chip, or the GeForce GPU's will enable full rendering at the device 10.

While full 3D photorealistic rendering is difficult with the device 10 described herein standing alone, advances in processing and rendering capability will enable greater use of 3D graphics in the future. In a particular application, such as NASCAR, a car object and a track object (e.g., Taladega) can be rendered in advance and stored, making realistic 3D graphics possible. However, a preferred form is to use a cloud-based gaming provider, such as OTOY, OnLive, or Gaikai at server 44 networked to devices 10.

While the invention has been described in the context of viewing an “event” at a venue for better understanding, it is understood that an “event” is not limited to a sports event and can be ordinary life situations, such as meeting friends at a designated location or venue, or viewing or previewing a selected venue. Further, while the methods hereof are particularly applicable to outdoor sporting events, they are also applicable to any event, even indoor events, such as concerts, political rallies, mash ups, crowds, and other public and ad hoc events. Therefore, viewing an “event” and viewing a “venue” should be considered interchangeable in the present application. See, e.g. U.S. patent application publication Ser. No. 12/146,907 (incorporated by reference).

What is claimed:

1. A method for viewing messages when viewing an event at a venue, comprising:
determining a position of one or more participants at the venue;
transmitting said position of a participant;
equipping a spectator with a computer having a graphics display;
communicating said participant position to said spectator;
viewing on the graphics display said participant position at the venue in a perspective view; and
inserting a georeferenced artificial reality message into the perspective view of the venue, wherein the message content is based on context.

2. The method of claim 1, wherein the context of said message is based on, at least in part, the demographics of likely spectators viewing said event.

3. The method of claim 1, wherein the context of said message is based on, at least in part, the demographics of said spectator viewing said event.

4. The method of claim 1, wherein the context of said message is based on, at least in part, the personal information of said spectator viewing said event.

5. The method of claim 1, wherein the context of said message based on, at least in part, the source of said perspective view of said spectator viewing said event.

6. The method of claim 1, wherein the context of said message based on, at least in part, the target of said perspective view of said spectator viewing said event.

7. The method of claim 1, wherein the context is based on one or more of: machine ID of the computer, search history, location history, personal information, social media participation, personal income, personal demographics, time of day, location, weather, loyalty program membership, media library, user opinion or opinions of friends and family.

8. The method of claim 1, wherein the message comprises a product, and a product image is inserted into said perspective view based on context.

9. The method of claim 1, wherein the spectator is remote from said venue and can select the origin of said perspective view.

10. A system for displaying messages to a spectator viewing an event taking place at a venue, comprising:
a positioning system for dynamically determining the position of a participant at the venue;
a radio for transmitting a plurality of positions of said participant as the participant moves;
a server which receives said transmitted participant positions;
a spectator device operable to receive said participant positions from said server;
said spectator device having a graphics display and operable by the spectator to select a spectator viewing location of said event for viewing said venue in a perspective view from said spectator selected viewing location; and
an artificial reality message transmitted from said server to said device and inserted into said perspective view with the content of said message based on context.

11. The system of claim 10, wherein said message is geo-referenced to a participant at said venue.

12. The system of claim 11, wherein the moving participant has an affixed fiducial and said message is inserted proximate said fiducial.

13. The system of claim 10, wherein said message is geo-referenced relative to a static location at said venue.

14. The system of claim 10, wherein said spectator is in attendance at said venue and said spectator viewing location is the GPS position of said spectator device.

15. The system of claim 10, wherein the context of said message is based on, at least in part, the demographics of said spectator viewing said event.

16. The system of claim 10, wherein the context is based on, at least in part, the demographics of likely spectators to an event at said venue.

17. The system of claim 10, wherein the context includes one or more of: machine ID of the computer, search history, location history, personal information, social media participation, personal income, personal demographics, time of day, location, weather, loyalty program membership, media library, user opinion or opinions of friends and family.

18. The system of claim 10, wherein the background environment of said perspective view is a virtual reality depiction of said venue.

19. The system of claim 10, wherein the background environment of said perspective view is a digital image of the venue taken with a camera in said spectator device.

20. The system of claim 10, wherein said message is a product image.
